(19) United States
(12) Patent Application Publication
(10) Pub. No.: US 2004/0267645 A1
(43) Pub. Date: Dec. 30, 2004

(54) Method and corresponding equipment enabling billing for use of applications hosted by a wireless terminal

(76) Inventor: Pekka Pollari, San Francisco, CA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/606,271

(22) Filed: Jun. 24, 2003

(51) Int. Cl. G06F 17/60

(52) U.S. Cl. 705/34

(57) ABSTRACT

A wireless terminal (10) and an operator network (18) adapted to enable billing a user of the wireless terminal (10) for use of an application (11) hosted by the wireless terminal (10). The application (11) is implemented so as to interface with a business relationship manager (BRM) (12) module also hosted by the terminal (10) via a BRM application programming interface (API) included in the BRM (12), and the BRM (12) ensures that the application (11) is not used by the user unless it is registered with the operator network (18) so that the user is billed for use of the application according to one or another lease/buy plan elected by the user. The BRM (12) also enables registration, de-registration, and even charging for use of network resources by the application (11).

### FIELD OF THE INVENTION

The invention has to do with the use of applications hosted by wireless terminals, and more particularly with enabling billing for such use.

### BACKGROUND ART

Smaller software companies often offer their products as shareware. A user is allowed a limited time to try a product free of charge, and at the end of the trial period the user must pay for the product in order to keep using the product. The payment is usually handled by sending a check to the software company. Such a series of transactions is cumbersome and so sometimes tends to dissuade potential customers.

In case of telecommunications, the development of new applications is critical to the continued evolution of the state of the art. To promote the development of new applications for users of wireless terminals, what is needed is a less cumbersome way to facilitate having a user pay for use of an application hosted by a wireless terminal, ideally a way that does not involve the user having to transact business with individual application developers, and so a way to pay for an application that is the same regardless of the entity making the application available, and regardless of how the application is installed on the wireless terminal, i.e. regardless of where the application is downloaded from or whether the application is placed in the wireless terminal at the manufacturing facility for the wireless terminal. The mobile software market is somewhat limited with the dynamics and scalability of the current solutions. The enhanced scalability of the software market can be achieved by utilizing DRM (digital rights management) so-called super-distribution, but the dynamic part (changes in charge plans, etc.) is more challenging since there is at present no feedback from the mobile terminal to the network operator with respect to the use of an application on the mobile terminal.

### SUMMARY OF THE INVENTION

Accordingly, in a first aspect of the invention, a method is provided for enabling billing a user for use of an application hosted by a wireless terminal subscribed to an operator network, characterized by: a step in which, in response to an indication by the user that the application is to be executed, a business relationship manager (BRM) also hosted by the wireless terminal refers to one or more data stores hosting information on user registration of applications to determine whether the user has registered the application; and a step in which, if the BRM determines that the user has registered the application, the BRM then signals to the application that the user has registered the application.

In accord with the first aspect of the invention, the method may be further characterized by: a step in which, before a first use of the application, the user registers the application with a user information server via the BRM. Further, signalling between the BRM and the user information server may be according to SIP (session initiation protocol) or XML (extensible markup language) over HTTP (hypertext transfer protocol) or over HTTPS (secure HTTP). Also further, the method may be further characterized by: a step (25f) in which, before registering for use of the application, the user elects in a dialogue with the BRM a lease/buy plan by which the user is billed for use of the application.

Also in accord with the first aspect of the invention, to determine whether the user has registered the application, the BRM may refer to a data store hosted by the wireless terminal.

Also in accord with the first aspect of the invention, to determine whether the user has registered the application, the BRM may refer to a data store maintained by a user information server of the operator network.

Also in accord with the first aspect of the invention, the method may be further characterized by: a step in which, in response to a prompt by the user to de-register the application, the BRM signals a de-register message to a user information server that the application is to be de-registered for the user; and a step in which the user information server acknowledges the de-register message and de-registers the application for the user.

Also in accord with the first aspect of the invention, the application may be assigned an identifier common to all copies of the application and used as an identifier for the application in the data stores indicating whether the user has registered the application.

Also in accord with the first aspect of the invention, the user may be able to elect various plans for paying for use of the application. Further, the various plans may include a plan in which the user is billed monthly for use of the application.

Also in accord with the first aspect of the invention, the application may consume network resources and the method may be further characterized by: a step in which with each request for a network service, the BRM appends to the request an identifier indicating the user and an identifier indicating the application; and a step in which a support node of the operator network counts packets bearing the identifier indicating the user and the identifier indicating the application. Further, the support node may be a gateway GPRS (general packet radio service) support node (GGSN).

Still also in accord with the first aspect of the invention, the application may be provided to the operator network by an application provider, and operator network may bill the user for use of the application and may compensate the application provider in a way predetermined to be commensurate with the use of the application by the user.

In a second aspect of the invention, a wireless terminal is provided including a BRM component for enabling billing a user for use of an application hosted by the wireless terminal subscribed to an operator network, the wireless terminal characterized in that the BRM comprises: means, responsive to an indication by the user that the application is to be executed, for referring to at least either a local data store or a data store hosted by the operator network to determine whether the user has registered the application; and means for signaling to the application that the user has registered the application in case the BRM determines that the user has registered the application.

In a third aspect of the inventions a wireless terminal is provided for use by a user, characterized by: an application, responsive to a signal to begin execution, for providing a signal to confirm registration, and further responsive to a signal indicating registration is in place; a BRM having a BRM application programming interface (API), responsive to the signal to confirm registration, for referring to at least one data store to determine whether the user has registered the application; and, if the BRM determines that the user has registered the application, for signalling to the application that registration is in place.

In a fourth aspect of the invention, a system is provided enabling billing a user of a wireless terminal for use of an application hosted by the terminal, comprising the wireless terminal and an operator network to which the user of the wireless terminal is subscribed, the operator network including a user information server, characterized in that: a BRM included in the wireless terminal is responsive to a signal from the application to confirm registration and signals a request to the operator network to determine whether the user is registered to use the application; and the user information server, in response to the request to determine whether the user is registered to use the application, refers to a data store hosted by the operator network to determine whether the user is registered to use the application.

In accord with the fourth aspect of the invention, the system may further comprise a gateway GGSN, and the system may be further characterized in that: in case of an application using network resources, for each request for a network service, the BRM appends to the request a user identifier and an application identifier, and the GGSN, by monitoring packets received from users, counts packets bearing the user identifier and application identifier.

In a fifth aspect of the invention, a computer program product is provided comprising: a computer readable storage structure embodying computer program code thereon for execution by a computer processor in a wireless terminal, said computer program product for enabling billing a user for use of an application hosted by the wireless terminal subscribed to an operator network, said computer program code characterized in that it includes instructions for performing the steps of a method provided according to the first aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram of a wireless terminal and an operator network to which the wireless terminal is subscribed, with the wireless terminal including a Business Relationship Manager (BRM) and an application implemented so as to interface with a BRM application programming interface (API) component of the BRM, according to the invention.

FIG. 2 is a flow chart indicating steps in a scenario in which a user of the wireless terminal of FIG. 1 registers the application.

FIG. 3 is a flow chart indicating steps in a scenario in which a user of the wireless terminal of FIG. 1 de-registers the application.

FIG. 4 is a flow chart indicating steps in a scenario in which a user of the wireless terminal uses the application according to a lease/buy plan in which the user is charged per use of the application.

FIG. 5 is a flow chart indicating steps in a scenario in which a user of the wireless terminal of FIG. 1 uses the application, which in turn uses network resources, and information is collected to enable billing the user for use of the network resources by the application.

FIG. 6 is a schematic of a tabular representation of a data store used by the operator network for billing for use of the application of FIG. 1.

FIG. 7 is a drawing of two terminals, one offering to a user a payment plan for use of an application without making clear that the user would be entering into an agreement the network operator, and the other terminal making it clear to the user that the agreement would be between the network operator and the user, as opposed to some other entity, such as the application developer.

FIG. 8 is a schematic of the software architecture in a mobile terminal, according to the invention.

### BEST MODE FOR CARRYING OUT THE INVENTION

The invention is described for embodiments in which SIP signaling is used, but it should be clear from the description that follows that nothing about the invention limits it to such embodiments. Other kinds of signaling are equally suitable, including e.g. signaling using XML (extensible markup language) over HTTP(s) (hypertext transfer protocol, either in the clear or via a secure socket layer).

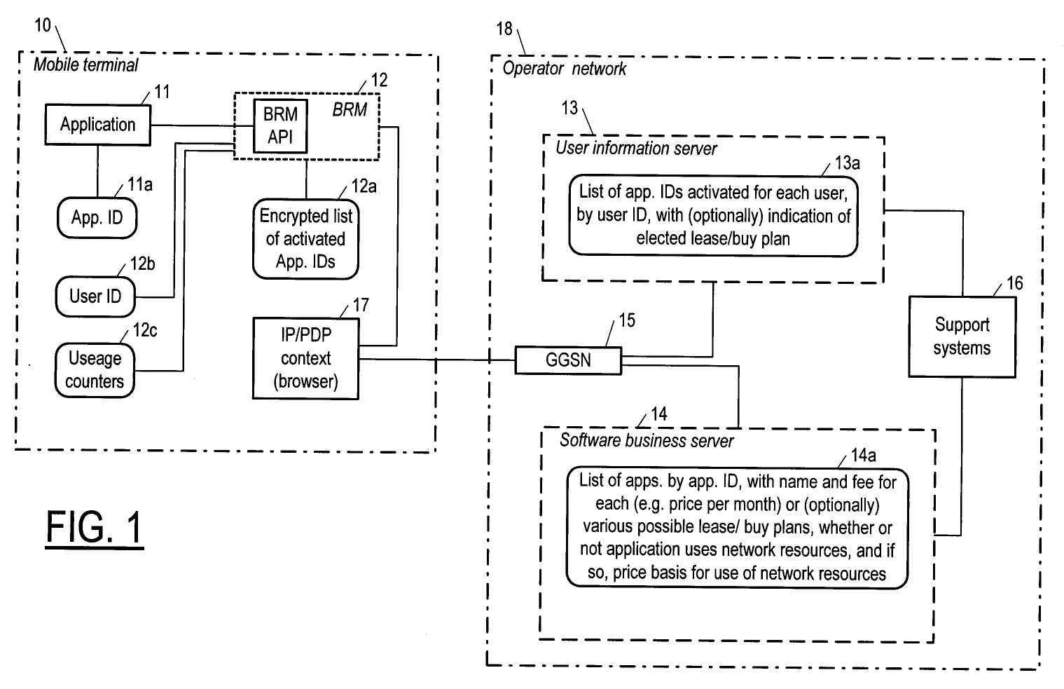

Referring now to FIG. 1, according to the invention, a mobile terminal 10 hosting an application 11 includes a business relationship manager (BRM) 12 that enables billing a user for use of the application by determining whether the user is registered with the operator network 18 to which the mobile terminal 10 is subscribed to use the application (on any piece of equipment), and, if the application 11 consumes network resources, then making possible an accounting of the use of the resources by appending to a request for such resources an identifier for the application 11 and (optionally, as needed) an identifier for the user, so that the operator network 18, and in particular a support node such as a gateway GPRS (general packet radio service) support node (GGSN) 15, is able to monitor the number of requests for network resources by monitoring packets coming from the mobile terminal 10 including the appended application identifier and user identifier. The BRM 12 communicates with the user information server 13 and the software business server 14 via the GGSN 15 and the browser 17.

Still referring to FIG. 1, it should be understood that FIG. 1 does not indicate the radio access network that couples the wireless terminal 10 to the operator network 18. A radio access network doing so is preferably according to 3GPP (Third Generation Partnership Program) Release 5 or later, but any version/release is suitable.

Still referring to FIG. 1, the application 11 must be implemented so as to include an interface with the BRM 12 utilizing the BRM API, and must indicate to the BRM 12 the application identifier for the application. The identifier would typically be stored at some memory location 11a within the wireless terminal 10. The identifier for the application is common to all copies of the application, and so is distinguished from a serial number type of identifier. The BRM 12 also has access to a memory location 12b holding the identifier for the user. The BRM 12 not only provides information to the application indicating whether the application is registered, but optionally prevents use of the application 11 by the user unless the application is registered, and also enables the user to register (and de-register) the application with the operator network 18, as described below. In addition, according to a preferred embodiment of the invention, the BRM 12 can be queried by a user for information about charges for use of an installed application or applications. For example, a user is able to ask for a list of all network registered applications (i.e. registered by the user), a list of all network registered application prices/use fees, and a total price/fee for use of the registered applications. In some cases, such as applications for which the user has indicated a desire to be billed on a per use basis, the BRM 12 would provide an indication of the cost per use of the application. In case of the use of applications that consume network resources, the BRM 12 would provide both an indication of the cost per month (or per use), and also an indication of the cost per request for use of network resources. In addition, the BRM 12 preferably uses digital rights management (DRM) to safeguard the application so that it is not altered and made to execute without first confirming with the BRM 12 that it is indeed registered for use by the user.

The BRM 12 uses (for example) session initiation protocol (SIP) for signaling to servers of the operator network 18. As another example, XML (extensible markup language) over HTTP(s)(hypertext transfer protocol (secure socket layer)) is use as the signaling protocol. To send a message to a particular server of the operator network 18, the IP address of the server is needed, and in the preferred embodiment of the invention, it is provided by a so-called smart message or some other over the air (OTA) function. When the user of the wireless terminal 10 executes the application 11, and the BRM 12 then checks with the operator network 18 that the application 11 is registered, the user is not charged for the SIP (or any other BRM-related signaling, such as XML over HTTP(s)) signaling required to check for registration, i.e. the operator network servers used in connection with registration reside in a “toll-free” subnet. When the BRM 12 communicates with a server of the operator network 18, it sends an identifier of the user with any message directed to the server, the message being typically encrypted, so that the server can identify the user and provide a response. The identifier of the user is preferably based on SIM (subscriber identity module) identifier information, such as for example IMSI (international mobile subscriber identifier), MSISDN (mobile subscriber ISDN (integrated services digital network) number), etc. An SIP message provided by the BRM 12 is, for example, exactly the same as a message defined in 3GPP Rel5 for SIP authentication. However, authentication according to the invention preferably does not use 3GPP Rel.5-specified x-CSCF (call state control function) functionality, but instead uses an operator network server. Note also that the authentication mechanism selected depends on network capabilities; more specifically, on 3GPP Rel.5 (and subsequent) networks, SIP authentication is suitable, but in other 3GPP releases (earlier than 3GPP rel. 5), XML over HTTP(s) should be used.

Still referring to FIG. 1, the operator network 18 includes a user information server 13 that in turn hosts a data store 13a holding a list of applications listed by application identifier activated for each user, with the user indicated by the user identifier. As mentioned, the user identifier is preferably a SIM-based user identifier, preferably in the form of the 3GPP Rel.5 SIP identifier, i.e. in the form of an SIP URL, and includes means for authentication. (This is valid when the network is 3GPP rel.5 capable. In other networks, XML over HTTP(s) should be used.) Also, as indicated above, any use of the user information server 13 is, according to the invention, free of charge.

The operator network 18 also includes a software business server 14 preferably including a data store 14a having a list of application identifiers, and for each application ID: a price, such as a monthly fee; and an indication of whether or not the application uses network resources, and, if so, the price of using the network resources, such as either a fixed price or a per megabyte price, or a per transaction price. As is the case for the user information server 13, use of the software business server 14 is preferably free of charge to the user. The GGSN 15 operates purely as an ordinary gateway except in case of applications that consume network resources, and then, as mentioned above, it may count requests by the application 11 for network resources.

Neither the user information server 13 nor the software business server 14 perform actual billing; instead support systems 16, which include a billing server and a subscriber service database, among other servers, perform billing based on information provided by the user information server 13 and software business server 14.

Throughout the operation of the invention, both an identifier application as well as a user identifier are used in combination, and the two identifiers in combination are here called a user-application identifier, which may be a concatenation of the two identifiers, and may also be encrypted.

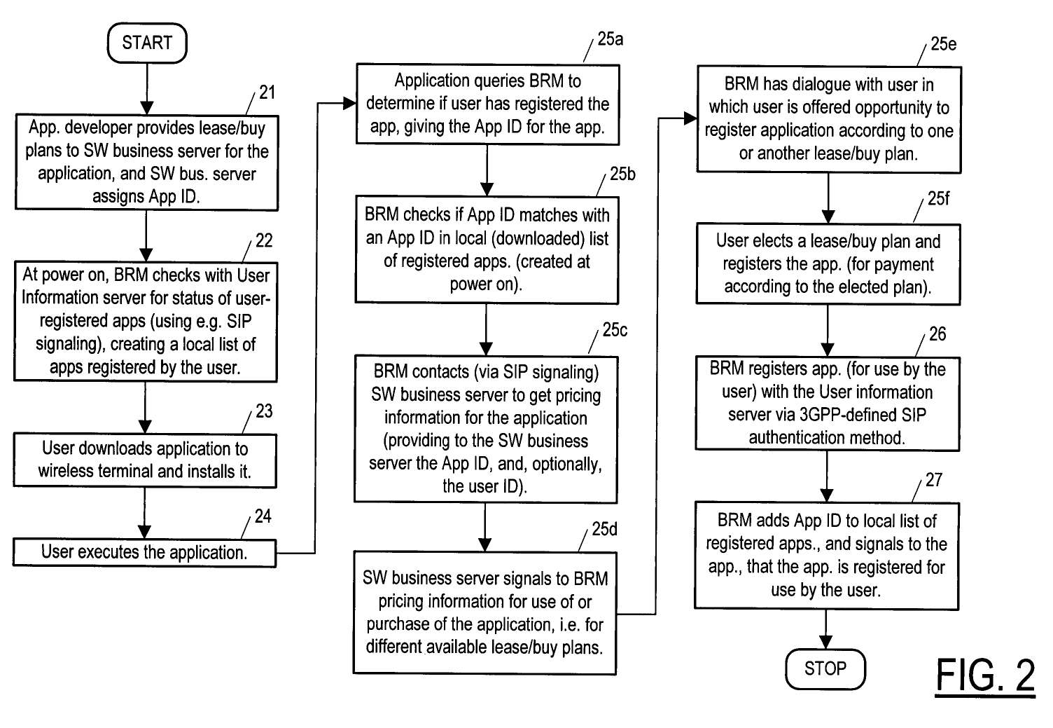

Referring now to FIG. 2, a scenario indicating use of the invention is shown as in beginning with a first step 21 in which an application developer provides lease/buy plans to the software business server 14 for use of the application, and the software business server assigns an application identifier to the application, an identifier that is, as mentioned, common to all copies of the application and so is distinguished from a serial number type of identifier. In a next step 18, at power on, the BRM 12 checks with the user information server 13 for the status of user-registered applications, using for example SIP signaling, and creates a local (on terminal) list of applications registered by the user. To create the local list of applications, the BRM of course requires access to the user identifier at the memory location 12b, and it includes the user identifier with its query to the user information server 13 for the list of user-registered applications. In a next step 23, (the present scenario being in case of the application 11 not yet having been downloaded), the user downloads the application 11 to the wireless terminal 10 and installs it. In a next step 24 the user executes the application. In a next step 25a, the application 11 queries the BRM utilizing API 12 to determine if the user has registered the application, passing the application identifier to the terminal API 12 as part of the query. In a next step 25b, the BRM checks whether the application identifier matches an application identifier in the local list of registered applications, and, in this scenario, since the application was just downloaded, does not find the application in the list. Therefore, in a next step 25c, the BRM 12 contacts the software business server 14 using SIP signaling (or XML over HTTP(s), as mentioned) to obtain pricing information for the application, providing the software business server with the application identifier, and also optionally, with the user identifier, in case there is special pricing available for the user. In a next step 25d, the software business server 14 signals to the BRM 12 the pricing information for use of or purchase of the application 11, i.e. it provides an indication of the different available lease/buy plans for the application 11. The lease/buy plans, as mentioned above, would have been provided to the software business server 14 by the application developer before the application 11 was made available for download or for including with the wireless terminal 10. In a next step 25e, the BRM has a dialog with the user in which the user is offered the opportunity to register the application according to one or another of the lease/buy plan provided by the software business server 14. In a next step 25f, the user does elect a lease/buy plan and registers the application 11 for payment according to the elected plan. In a next step 26, the terminal API registers the application for use by the user with the user information server 13, preferably via 3GPP-defined SIP authentication. In a next step 27, the BRM 12 adds the application identifier to the local list of registered applications, and signals to the application that the application is now registered for use by the user. If the user elects not to register the application, the BRM signals to the application 11 that the user has declined registration, and the application 11 would then indicate to the user that it is unavailable for use because it is not registered.

After the wireless terminal 10 is powered down, the data store 12a containing a list of applications for which the application is registered is preferably not deleted, because it can then be used when the terminal is powered on but there is no network coverage, in which case the BRM can still prevent or enable use of an application 11 by referring to the saved copy of the list of registered applications in the data store 12a.

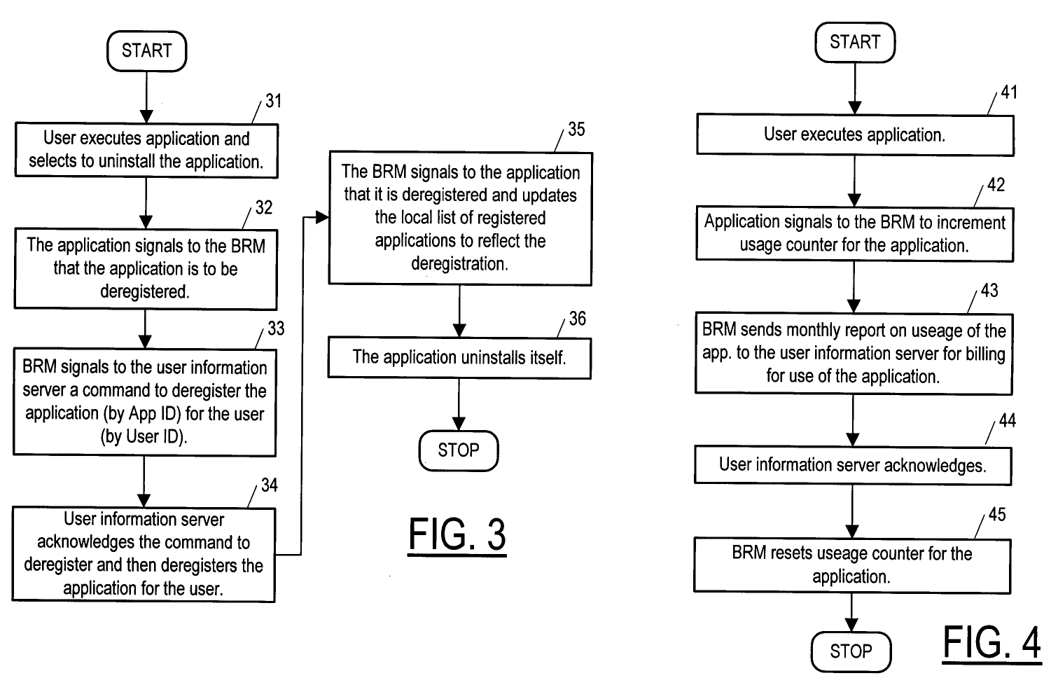

Referring now to FIG. 3, a scenario is illustrated in which a user deregisters an application. According to the scenario, in a first step 31, the user executes the application 11 and selects to uninstall it. In a next step 32, the application 11 signals to the BRM 12 using the BRM API that the user is indicated that the application is to be deregistered. In a next step 33, the BRM 12 signals to the user information server 13 that the user has elected to deregister the application, and in so signaling, the BRM provides the user information server with the user identifier and the application identifier. In a next step 34, the user information server acknowledges the command to deregister, and then does so. In a next step 35, the BRM 12 signals to the application that it is deregistered, and also updates the local list of registered applications in the data store 12a to reflect the deregistration. In a last step 36, the application uninstalls itself. In some scenarios, the application would not actually uninstall itself, but instead remains intact within the wireless terminal, although it is then not available for use unless the user again uses the BRM 12 to register the application with the user information server 13. It should also be pointed out that according to the invention, a user might use various different wireless devices of which more than one might include a copy of the application 11. However, the SIM card the end-user is using is the same in all devices, i.e. when switching terminals, the SIM card must be moved from the previous terminal and inserted into the new one. In such a situation, the user might use in the new terminal the same application as the user had been using in the old terminal. For this to happen, according to the invention, as soon as the application is executed the first time, the BRM 12 checks from the network 18 to determine whether the application is already registered (using same end-user ID as with previous terminal) and in such a situation (where the user is in fact already registered to use the application), the network 18 responds to the BRM 12 that the application is registered for use by the user and so the BRM 12 adds the application identifier into a local file (i.e. hosted by the new terminal) of registered applications. In other words, since the user registers an application (in the servers of the operator network 18) based on the user identifier and also based on the application identifier common to all copies of the application, once a user registers an application against a user identifier using one wireless terminal, the application is registered for all wireless terminals that the user might use. Thus, based on the information received from the network, a user is eligible to execute the application in any terminal in which the user inserts a SIM card having an identifier for which the application is registered.

Note that according to the preferred embodiment of the invention, whenever the user's SIM card is not in a terminal hosting an application the user might want to execute, the user cannot execute the application even if the application has already been registered by the user and so its identifier is on file in the terminal (and associated with the user identifier), since the terminal looks to the SIM card for a user identifier, and without a user identifier, the BRM 12 cannot verify that the user is registered to use the application.

Referring now to FIG. 4, a scenario is illustrated in which a user uses the application 11 according to a lease/buy plan in which the user pays for each use of the application instead of paying either a one-time fee or paying a monthly fee. In this scenario, it is assumed that the application does not use network resources, or that there is no charge for doing so. In the first step 41 of the scenario, the user executes the application 11. In a next step 42, the application 11 signals to the BRM 12 utilizing the BRM API a command to increment a usage counter for the application and maintained by the BRM. The user then proceeds to use the application, and steps 41 and 42 may then be repeated several times before, in a next step 43, the BRM sends a monthly report on usage of the application to the user information server 13 to enable billing for use of the application 11. In a next step 44, the user information server 13 acknowledges receiving the information from the BRM 12, and in a last step 45, the BRM 12 resets the usage counter for the application 11. The usage counter is preferably stored as an encrypted file data store 12c (FIG. 1). The BRM 12 can be programmed to update the user information server 13 with the information from the usage counters data store 12c after every so many number of power on initial program loads (boot procedures). In the preferred embodiment, usage is always tied to the end user identity, so that if somebody else is using the terminal i.e. if the terminal is being used with another SIM/IMSI, then the usage counter is updated for the corresponding user. Therefore, the usage counter can either be a file that includes as an index not only the application identifier, but also the user identifier, or alternatively, it can be stored on the SIM/IMSI card for each user, in which case of course there is no requirement to use the user identifier as an index, i.e. the usage can be stored by application identifier, and not both by application identifier and user identifier.

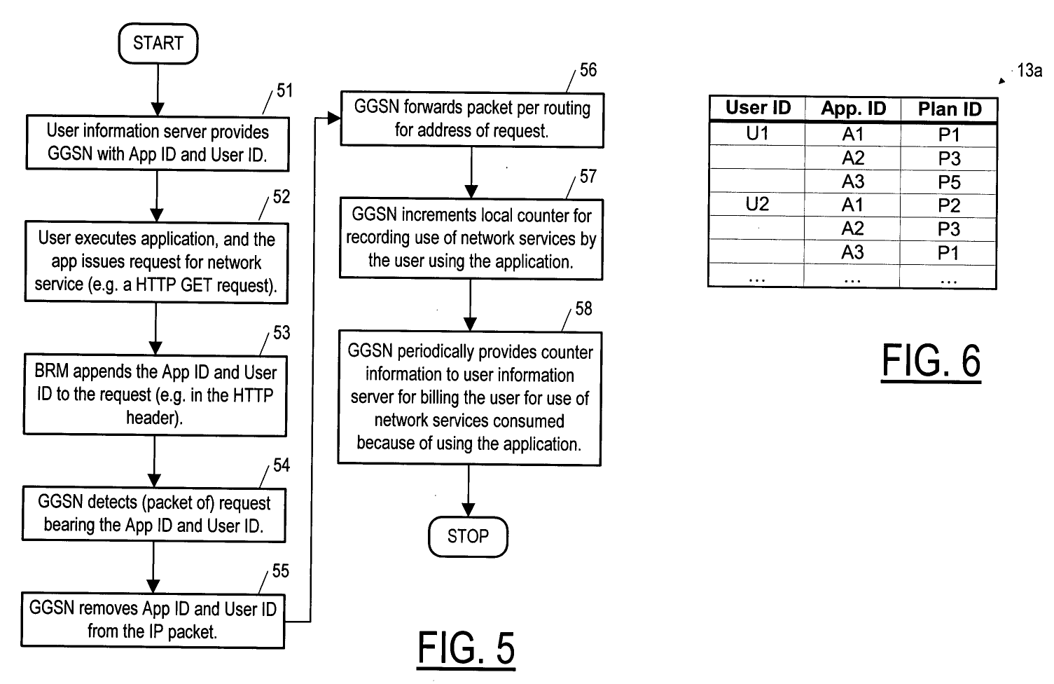

Referring now to FIG. 5, a scenario is illustrated in which a user is billed for use of an application not only as above, i.e. either a one-time fee, some monthly fee, or on a per use basis, but also based on the use of the operator network resources. For example, the application 11 may be one that provides a weather forecast, and when the user executes the application 11, the application 11 issues a HTTP Get request for information from a network server. The request is passed through the GGSN 15 (FIG. 1) and so there is an opportunity for monitoring the number of such requests (and corresponding replies) made by the application 11, and in fact the invention does make use of the GGSN 15 in providing such an accounting. Thus, in a first step 51, the user information server 13 provides the GGSN 15 with the application identifier and user identifier for the application 11 and a user that has registered with the user information server 13 for use of the application 11; the user information server 13 provides the GGSN 15 with the application identifier and the user identifier for the application 11 only in the case that the application 11 consumes network resources and the user is being charged for the use of the network resources. In a next step 52, some time later, the user executes the application 11, and the application issues a request for network service (i.e. an HTTP GET request). In a next step 53, the BRM 12 appends the application identifier and user identifier to the request for network service. In a next step 54, the GGSN 15, in monitoring the end user traffic (IP packets) for HTTP headers including an application identifier and user identifier, detects a packet that includes the added information (and may be just one of many packets used to convey the request for network service). The GGSN of course does not read information included in packets at the application layer, but does read information provided according to the IP or HTTP protocols; the BRM 12 adds the application identifier and user identifier to the HTTP header, which is visible to the GGSN 15. In a next step 55, the GGSN 15 removes the application identifier and the user identifier from the IP packet, and in a next step 56 forwards the packet according to routing determined to get the packet—a component of a request for network service—to the server providing the network service. In a next step 57, the GGSN 15 increments a local counter for recording use of network services by the user using the application 11. Finally, in a last step 58, the GGSN 15 periodically provides the counter information to the user information server 13 to enable billing the user for use of the network services consumed because of using the application 11. As mentioned, the user may also be billed for use of the application 11 independent of any request for network services made by the application 11.

In some embodiments of the invention, corresponding to providing as additional HTTP header information the application identifier and user identifier, the TOS/DSCP (Type-Of-Service/Differentiated Services Codepoint) fields in the IP packet can be optionally rewritten with proprietary or uncommon values. Doing so avoids relying on the GGSN to perform layer 7 processing. It is also possible to use other fields besides the TOS/DSCP fields, such as the IPV6 extension headers or IPV6 flow label fields. In removing the application identifier and user identifier from a packet, the GGSN 15 rewrites the TOS/DSCP fields with basic/default values.

Referring now to FIG. 6, the data store 13a of the user information server 13 (FIG. 1) is shown schematically as a table in which four of each various user identifiers an application identifier and a lease/buy plan identifier are indicated, so that for example user identifier U1 is shown as registered for use of an application having an application identifier A1 according to a lease/buy plan having a plan identifier P1.

It is important to understand that the invention differs from the prior art in that charging for use of an application is provided by the invention without regard for how the application is downloaded or is otherwise installed on a wireless terminal. In addition, the invention charges for use of an application based on the identity of the user, not the identity of the terminal being used, i.e. the lease/buy plans for applications are bound to the end user identity, not the terminal identity.

Also, the lease/buy plans can be complex and even personalized. For example, a particular user could be offered a special initial price/fee of for example three Euros for use of an application for three months, and then be charged at the rate of one Euro per month for the next 18 months, and after that, the user might have use of the application free of charge.

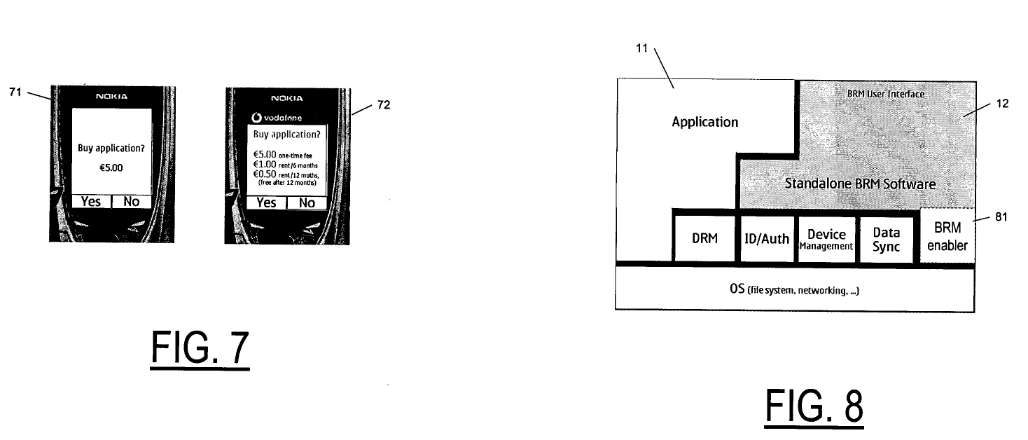

It is also important to understand that the invention provides what is here called operator-awareness, in the following sense. While a vendor of mobile terminals is responsible for pre-installed applications in the mobile terminals as well as the overall hardware, it is up to the network operator to be able to charge for the usage of network services. Traditionally this has meant circuit-switched voice calls as well as GPRS data network usage. When 3^{rd} party software is installed in a terminal, it is possible that the network operator is not involved in a business relationship between the end-user and the 3^{rd}-party software developer, but in cases where the operator is charging the end-user on behalf of the 3^{rd} party developer, the operator really has a business relationship with the end-user regarding use of applications developed by the 3^{rd} party application developer. Hence, the business relationship with the end-user and the operator must be clearly visible. This is achieved by introducing operator-awareness in the BRM 12 in the mobile terminal. In practice, operator-awareness is binded into a SIM-card in the mobile terminal. By switching SIM cards, it is possible to have a different “look and feel” to the BRM 12. While the overall content of the BRM must be common (according to the BRM version, that is), the colors, operator logos and icons are updateable to reflect the current operator, based on the information received from the SIM card. The logos, colors and other such information is automatically downloaded from the user information server 13 in the operator network 18 (FIG. 1). The downloaded information can be dynamic and it is also possible to push a new “look and feel” into the end-user's terminal. FIG. 7 shows a mobile terminal 71 in which the look and feel of the BRM 12 has not been adapted to make evident to the user that it is the operator with whom the user is establishing a business agreement in electing to rent an application; and FIG. 7 also shows another mobile terminal 72 in which the look and feel of the BRM 12 has been adapted to make evident to the user that it is the operator with whom the user is establishing a business agreement in electing to rent an application.

Referring now to FIG. 8 (and also again to FIG. 1), software architecture of the terminal 10 is shown with the BRM 12 as preferably standalone software, executing on top of the operating system (OS), and the BRM API (see FIG. 1) is part of the BRM 12, i.e. the BRM API is utilized between the application 11 and the standalone BRM software. A DRM (digital rights management) module, an ID/Authentication module, and a Data Synchronization module are examples of so-called common utilities/enablers also typically included in the terminal 10. A utility or enabler, as used here, is a standalone module providing in the mobile terminal a usually specific functionality, such as authentication, DRM and so on; a utility/enabler can be used (called) by any (calling) application (the utilities sometimes being called shared applications), thus avoiding having to implement the functionality provided by the common utility in each different application.

An optional BRM utility is also shown as standalone software, used for end-user actions, such as for example checking charging for installed applications.

The BRM software has a user interface that can be made such that the BRM makes clear the operator-user relationship. Note that the BRM 12 preferably does not utilize a web/web-browser but is instead standalone software because it is then possible to provide heightened security compared to what would be available using a browser to provide the BRM 12 functionality. (Of course, as browser-based applications become more secure, it may become advantageous to embed the BRM functionality in a browser.)

Thus, the invention, which can be considered to provide a network-centric software business (NCSB) framework, enables a convenient way for an end-user to try, buy, consume and switch applications designed for mobile terminals. In addition, it is possible to rent an application, as well as install multiple copies of the same application into several mobile terminals (but only use one at a time, since the user SIM card must be present in the terminal). The invention is preferably implemented so that only a single click by a user is needed to enable or disable application charging according to a charging plan selected by the user (after the user views different charging plans also using a single-click interface).

The NCSB framework provided by the invention is fully dynamic, i.e. as an example: when the charge for a rented application changes, it is possible to push a notification of the change into the mobile terminal without any end-user initiated action. It is, of course, up to the end-user to then decide whether to continue to keep the application registered according to the new charge plan. As a second example: it is possible that an application might be free of charge after a certain period of charged-for time, and the switch to free can be made automatically according to the invention; moreover, the agreement for use of the application might be such that the application is charged for again after a further period of time, and it is possible according to the invention to then push a notification of the change back to charging into the mobile terminal without any end-user initiated action.

The NCSB framework creates an ecosystem for small and medium-sized software companies, mobile operators, software aggregators and end-users. The ecosystem provides a simple, easy and seamless mechanism for application developers to create and sell applications, without having to invest in large supporting (distribution infrastructure) systems, such as a worldwide billing system, customer databases and so on. A personal computer and a bank account should be enough. Correspondingly, end-users are able to buy and use applications via a simple user interface in a mobile terminal that creates an agreement between the user and the network operator, and so without any need for personal registration, ordering, payment or any other form of inserting or sending information to an application developer. The network operator receives additional revenue from the “low-end” software market, which would otherwise be unavailable. All that is required of the network operator is a small investment in adapting the network servers to be operative according to the invention. (Both network-consuming and non-network consuming applications are important for the operator.)

According to the NCSB framework provided by the invention, the software aggregator acts as a central hub for application developers and it treats them as a crucial resource, therefore providing both technical and legal support, in all relevant countries. The software aggregator acts also as a centerpiece of the developer community, driving additions and enhancements to the NCSB ecosystem. Finally, the software aggregator provides information to network operators about application usage and corresponding revenues.

It is to be understood that the above-described arrangements are only illustrative of the application of the principles of the present invention. Numerous modifications and alternative arrangements of what is disclosed here may be devised by those skilled in the art without departing from the scope of the present invention, and the appended claims are intended to cover such modifications and arrangements.

What is claimed is:

1. A method enabling billing a user for use of an application (11) hosted by a wireless terminal (10) subscribed to an operator network (18), characterized by:
a step (25b 25c) in which, in response to an indication by the user that the application (11) is to be executed, a business relationship manager (BRM) (12) also hosted by the wireless terminal (10) refers to one or more data stores (12a 13a) hosting information on user registration of applications to determine whether the user has registered the application (11); and
a step (27) in which, if the BRM (12) determines that the user has registered the application (11), the BRM (12) then signals to the application (11) that the user has registered the application (11).

2. A method as in 1, further characterized by: a step (26) in which, before a first use of the application (11), the user registers the application (11) with a user information server (13) via the BRM (12).

3. A method as in 2, wherein signalling between the BRM and the user information server is according to SIP (session initiation protocol) or XML (extensible markup language) over HTTP (hypertext transfer protocol) or over HTTPS (secure HTTP).

4. A method as in 2, further characterized by: a step (25f) in which, before registering for use of the application (11), the user elects in a dialogue with the BRM (12) a lease/buy plan by which the user is billed for use of the application (11).

5. A method as in 1, wherein to determine whether the user has registered the application (11), the BRM (12) refers to a data store (12a) hosted by the wireless terminal (10).

6. A method as in 1, wherein to determine whether the user has registered the application (11), the BRM (12) refers to a data store (13a) maintained by a user information server (13) of the operator network (18).

7. A method as in 1, further characterized by:
a step (33) in which, in response to a prompt by the user to de-register the application (11), the BRM (12) signals a de-register message to a user information server (13) that the application is to be de-registered for the user; and
a step (34) in which the user information server (13) acknowledges the de-register message and de-registers the application (11) for the user.

8. A method as in 1, wherein the application (11) is assigned an identifier common to all copies of the application (11) and used as an identifier for the application (11) in the data stores (12a 13a) indicating whether the user has registered the application (11).

9. A method as in 1, wherein the user is able to elect various plans for paying for use of the application.

10. A method as in 9, wherein the various plans include a plan in which the user is billed monthly for use of the application.

11. A method as in 1, wherein the application consumes network resources and the method is further characterized by:
a step (53) in which with each request for a network service, the BRM (12) appends to the request an identifier indicating the user and an identifier indicating the application (11); and
a step (57) in which a support node (15) of the operator network (18) counts packets bearing the identifier indicating the user and the identifier indicating the application.

12. A method as in 11, wherein the support node (15) is a gateway GPRS (general packet radio service) support node (GGSN).

13. A method as in 1, wherein the application (11) is provided to the operator network (18) by an application provider, and operator network (18) bills the user for use of the application (11) and compensates the application provider in a way predetermined to be commensurate with the use of the application (11) by the user.

14. A wireless terminal (10) including a business relationship manager (BRM) (12) component for enabling billing a user for use of an application (11) hosted by the wireless terminal (10) subscribed to an operator network (18), the wireless terminal (10) characterized in that the BRM (12) comprises:
means (25b 25c), responsive to an indication by the user that the application (11) is to be executed, for referring to at least either a local data store (12a) or a data store (13a) hosted by the operator network (18) to determine whether the user has registered the application (11); and
means (27) for signaling to the application (11) that the user has registered the application (11) in case the BRM (12) determines that the user has registered the application (11).

15. A wireless terminal (10) for use by a user, characterized by:
an application (11), responsive to a signal to begin execution, for providing a signal to confirm registration, and further responsive to a signal indicating registration is in place;
a business relationship manager (BRM) (12) having a BRM application programming interface (API), responsive to the signal to confirm registration, for referring to at least one data store (12a 13a) to determine whether the user has registered the application (11); and, if the BRM (12) determines that the user has registered the application (11), for signalling to the application (11) that registration is in place.

16. A system enabling billing a user of a wireless terminal (10) for use of an application (11) hosted by the terminal (10), comprising the wireless terminal (10) and an operator network (18) to which the user of the wireless terminal (10) is subscribed, the operator network (18) including a user information server (13), characterized in that:
a BRM (12) included in the wireless terminal (10) is responsive to a signal from the application (11) to confirm registration and signals a request to the operator network (18) to determine whether the user is registered to use the application (11); and
the user information server (13), in response to the request to determine whether the user is registered to use the application (11), refers to a data store (13a) hosted by the operator network (18) to determine whether the user is registered to use the application (11).

17. A system as in claim 16, further comprising a gateway GPRS (general packet radio service) support node (GGSN) (15), and the system is further characterized in that: in case of an application using network resources, for each request for a network service, the BRM (12) appends to the request a user identifier and an application identifier, and the GGSN, by monitoring packets received from users, counts packets bearing the user identifier and application identifier.

18. A computer program product comprising: a computer readable storage structure embodying computer program code thereon for execution by a computer processor in a wireless terminal (10), said computer program product for enabling billing a user for use of an application (11) hosted by the wireless terminal (10) subscribed to an operator network (18), said computer program code characterized in that it includes instructions for performing the steps of the method of claim 1.
